(19) United States
(12) Patent Application Publication
(10) Pub. No.: US 2009/0321390 A1
(43) Pub. Date: Dec. 31, 2009

(54) CHEMICAL MECHANICAL POLISHING OF MOISTURE SENSITIVE SURFACES AND COMPOSITIONS THEREOF

(76) Inventor: Yuzhuo Li, Norwood, NY (US)

Correspondence Address: FROMMER LAWRENCE & HAUG, 745 FIFTH AVENUE- 10TH FL., NEW YORK, NY, 10151, US

(21) Appl. No.: 12/514,131

(22) PCT Filed: Nov. 7, 2007
(86) PCT No.: PCT/US07/83949

§ 371 Date: Jun. 30, 2009

Related U.S. Application Data
(60) Provisional application No. 60/864,809, filed on Nov. 8, 2006.

(51) Int. Cl. B44C 1/22; C09K 13/00

(52) U.S. Cl. 216/53; 252/79.1

(57) ABSTRACT

The present invention relates to compositions for chemical mechanical polishing (CMP—also referred to as chemical mechanical planarization) for fabrication of an advanced optical, photonic, or microelectronic device, wherein the composition is a microemulsion.

### INCORPORATION BY REFERENCE

Any foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

### FIELD OF THE INVENTION

The present invention relates to compositions for chemical mechanical polishing (CMP) for fabrication of an advanced optical, photonic, or microelectronic device, wherein the composition is a microemulsion.

### BACKGROUND OF THE INVENTION

Chemical mechanical polishing (CMP—also referred to as chemical mechanical planarization or chemical mechanical etching) is a well-known technology used in fabricating advanced photonic, microelectromechanical (MEM), and microelectronic devices, such as semiconductor wafers. See e.g. Chemical-Mechanical Processing (Springer Series in Materials Science), Michael R. Oliver, Springer Publ., (Mar. 24, 2006); Microchip Fabrication, Peter Van Zant, McGraw-Hill (2004); Chemical Mechanical Polishing in Silicon Processing, Volume 63 (Semiconductors and Semimetals), Eds. Shin Hwa Li and Robert O. Miller, Academic Press (1999); Chemical Mechanical Planarization of Microelectronic Materials, Steigerwald et al., John Wiley & Sons (1997).

In a typical chemical mechanical polishing process, a rotating wafer holder brings the wafer to be in contact with a polishing pad or CMP pad. One of the key consumables in conventional CMP processes is the CMP pad or polishing pad. The CMP pad is mounted on a rotating platen. A polishing medium, such as an abrasive slurry, is applied between the wafer and the pad. Examples of polishing slurries are known in the art, e.g. U.S. Pat. Nos. 7,091,164; 7,108,506 and 7,112,123. An abrasive slurry for metal CMP generally contains an oxidizer, abrasive particles, a complexing agent, and a passivating agent. Abrasive-free CMP processes are also known, see e.g. U.S. Pat. Nos. 6,800,218 and 6,415,697) In an abrasive-free system, the abrasive particles are removed from the polishing medium. An abrasive slurry for dielectric CMP generally contains abrasive particles and chemical additives that assist the removal of step height of the surface and stabilize the particle dispersion.

CMP slurries or solutions are often water-based. The advantages of a water-based slurry or solution include reduced production costs and environmental friendliness. For most applications, a water-based slurry or solution performs well due to the fact that the surfaces to be polished are usually inert to water. For some applications, however, the surface to be polished may be water sensitive or the surface may be reactive to moisture. For example, inorganic salt surfaces may be dissolved in the presence of water. For these surfaces, the use of water based slurry will be counterproductive. More specifically, contact between water and moisture sensitive surface will cause significant high static etch rate. Such an isotropic dissolution is detrimental to a CMP process. The direct consequence of such direct contact may lead to loss of step height reduction efficiency or loss of the ability to remove the surface roughness. Furthermore, a prolonged exposure of water or moisture to the polished surface will also lead to the formation a layer of haze on the surface, i.e. a cloudy appearance instead of transparent or clear surface.

Therefore, there still exists a need in the art for a CMP solution or slurry which is appropriate for general use and is also appropriate for use when polishing surfaces which are sensitive or reactive to moisture. It would also be desirable if the CMP solution or slurry would have a high material removal rate (MRR) while still maintaining acceptable polishing/planarizing characteristics. It would also be desirable if the slurry was able to achieve a polished surface with a protective layer against attack from the environment.

Citation or identification of any document in this application is not an admission that such document is available as prior art to the present invention.

### SUMMARY OF THE INVENTION

The object of the present invention is to provide a CMP solution or slurry which is appropriate for use in a process for chemical mechanical polishing.

This and other objects of the invention are achieved by providing a CMP solution which is a microemulsion with a reverse micelle system which comprises:

(a) a dispersed phase;
(b) a continuous phase; and
(c) a surfactant.

Another object of the invention is to provide a CMP slurry which comprises a solid material added to the CMP solution.

Another object of the invention is to provide a process of making the CMP solution or slurry which comprises mixing the individual dispersed phase, continuous phase and surfactant components.

Another object of the invention is to provide a method of chemical mechanical polishing which comprises using the CMP solution or slurry of the invention.

It is the object of the present invention to address at least some of these CMP slurry design criteria in an efficient cost effective manner.

Surprisingly, these objects of the invention are able to act as polishing agents for moisture sensitive or reactive surfaces and are also able to provide at least one additional benefit selected from the group consisting of high material removal rate, achieving high step height reduction efficiency and providing a protective surfactant layer on the polished surface.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

All “% by weight” is based on the total weight of the composition, solution or slurry except where otherwise indicated.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

The various embodiments and examples of the present invention as presented herein are understood to be illustrative of the present invention and not restrictive thereof and are non-limiting with respect to the scope of the invention.

These and other embodiments are disclosed or are apparent from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 depicts a regular micelle system with an aqueous continuous phase with the head (polar) groups facing out and tail (hydrophobic) groups facing in;

FIG. 2 depicts a reversed micelle system with an oil continuous phase with the head (polar) groups facing in and tail (hydrophobic) groups facing out;

FIG. 3 depicts a polished surface covered by a double layer of surfactant with opposite charge;

FIG. 4 depicts a polished surface covered by a double layer of mixed surfactant with opposite charges which enhance packing density and protection against moisture.

FIG. 5 depicts a phase diagram for a ternary system that contains pentanol (labeled as CoS), water and dodecyl sulfate (labeled as surfactant). For ease of readability, only two of the many possible phases are depicted (microemulsion phase labeled as micelles and reverse microemulsion labeled as Inverse micelles);

### DETAILED DESCRIPTION OF THE INVENTION

The present invention describes the formulation of a CMP solution or slurry that is designed to polish and protect moisture sensitive surfaces. The chemical composition of the CMP solution is a microemulsion in the L2 region of a phase diagram consisting of aqueous, oil, and surfactant components. The region typically contains reversed micelles.

In one embodiment of the invention, the CMP solution is a microemulsion with a reverse micelle system which comprises:

(a) a dispersed phase;
(b) a continuous phase; and
(c) a surfactant.

A microemulsion is a thermodynamically stable homogeneous single phase and has been well described in the art (see e.g. Handbook of Microemulsion Science and Technology, Editor: Promod Kumar, CRC Press (1999); Micelles, Microemulsions, and Monolayers, Editor: Dinesh O. Shah, CRC Press (1998); Industrial Applications of Microemulsions (Surfactant Science Series), Editors: Solans and Kuneida, CRC Press (1996); Microemulsion Systems (Surfactant Science Series); H. L. Rosano, CRC Press (1987); Microemulsions Structure and Dynamics, Editor: Pierre Bothorel, Author: Stig Friberg CRC Press (1987).)

In a regular microemulsion, water is typically the continuous phase and surfactant based micelles may encapsulate some oil which is the dispersed phase. In a reversed micelle system, the oil or organic layer is typically the continuous phase and surfactant based micelles that may capture some water which is now the dispersed phase. When a reversed phase micelle system is in direct contact with a moisture sensitive surface, the average contact time between water trapped in the micelles and the moisture sensitive surface is usually much shorter than that in a regular micelle system.

When this design is used in polishing/planarizing moisture sensitive surface, the surface are exposed with small amount of water that is capable of modified the surface to a softer layer and is ready to be removed mechanically. While not wishing to be bound by theory, at the protruded area the disruption of micelles system is greater than those at lower area due to an increase in shear force or temperature. Furthermore, a reversed micelle system is rich in surfactant molecules. When properly designed, the attraction force between the surface and the charged head group can be strong enough to allow a layer of surfactant molecules to form on the surface that is polished. The layer of the surfactant may be a single layer or multiple layer.

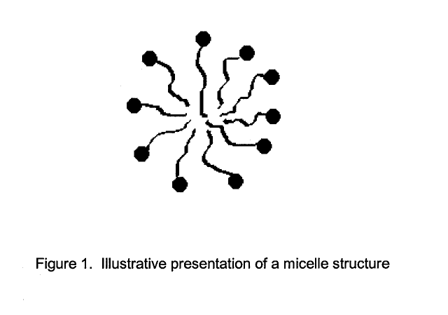

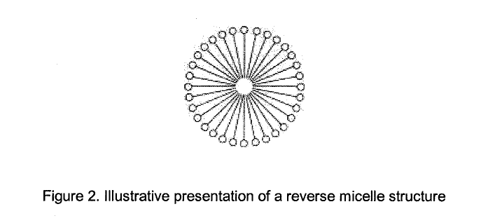

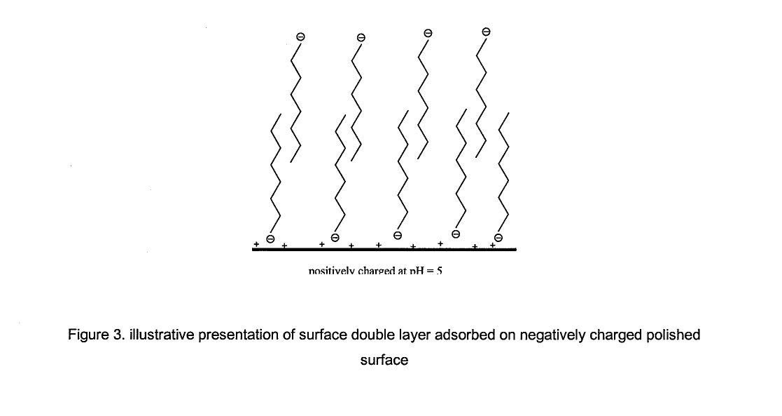

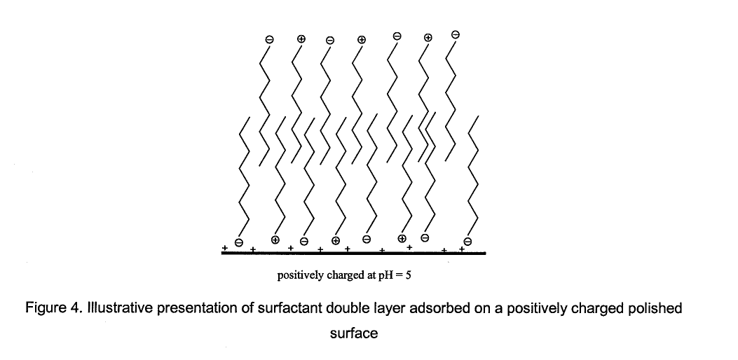

FIG. 1 schematically illustrates the chemical arrangement of a regular micelle system. FIG. 2 illustrates a reversed micelle system. FIG. 3 illustrates a surface left with a protective surfactant layer. It is important to note that the protective layer is most effective when the surfactant has a charge that is opposite of that of the polished surface. Furthermore, based on our previous study, when a set of mixed surfactants is used, it is possible to form a double layer with greater packing density on the surface and give even greater protection against moisture attack (FIG. 4).

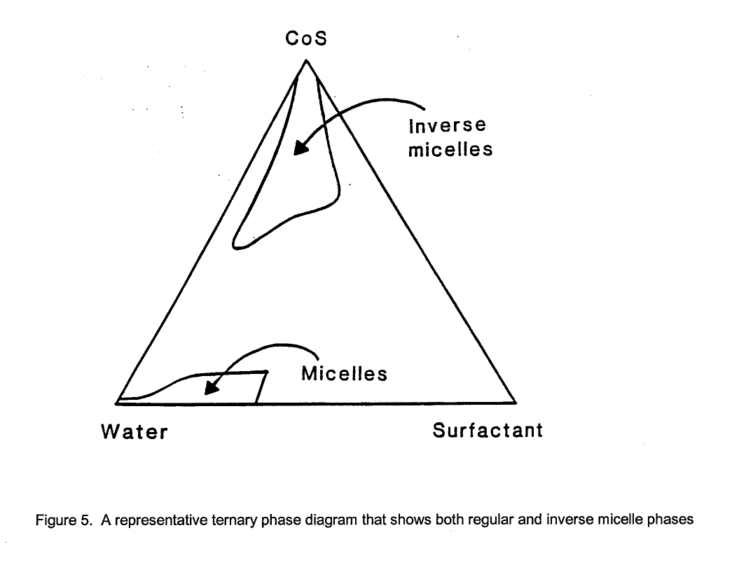

The chemical composition of such reversed micelle system can be experimentally determined by those of ordinary skill in the art. The phase boundaries can be experimentally determined and serve as a guideline for the preparation of a reversed micelle system. An example of such a system is illustrated in FIG. 5 which shows a surfactant such dodecyl sulfate (SDS), an oil or co-surfactant such as pentanol, and water forming a ternary system. The phase boundaries determined by experiments can be depicted in the phase diagram. The region that is labeled as L2 is typically reserved for reversed micelle system. L1, on other hand, is often used to describe a regular micelles system. A solid dispersed phase can not be described in a phase diagram as the phase diagram is a reflection of thermodynamic behavior of a particular system. As the solid particles themselves are a separate phase and will never reach equilibrium with the dispersed phase, the system is deemed thermodynamically unstable. For this system, there will be no corresponding phase region although that the system could be kinetically stable for a long time.

In one embodiment of the CMP solution, the microemulsion is an L2 microemulsion. In one embodiment of the L2 microemulsion, the amount of dispersed phase is about 5 to about 40% by weight, the amount of continuous phase is about 30% to about 94% by weight and the amount of surfactant is about 1 to about 30% by weight. In another embodiment of the L2 microemulsion, the amount of dispersed phase is about 8 to about 25% by weight, the amount of continuous phase is about 55% to about 89% by weight and the amount of surfactant is about 3 to about 20% by weight. In yet another embodiment of the L2 microemulsion, the amount of dispersed phase is about 10 to about 15% by weight, the amount of continuous phase is about 73% to about 82% by weight and the amount of surfactant is about 8 to about 12% by weight.

In one embodiment of the CMP solution, the dispersed phase includes but is not limited to water, an amine, an alcohol or mixtures thereof. In one embodiment of the dispersed phase, the dispersed phase is water. The dispersed phase should have a pH which is compatible or reactive with the surface to be polished. For example, to polish a surface that is strongly basic a dispersed phase that is acidic will enhance the reactivity. On other hand, a basic dispersed phase will modulate the reactivity to desired level. More specifically, a group I, II, or III metal oxide that is typically basic in nature will reactive with a acidic dispersed phase.

In one embodiment of the CMP solution, the composition of the continuous phase includes but is not limited to an oil, a hydrocarbon, an alcohol, an amine, or mixtures thereof.

In one embodiment of the continuous phase, the phase is comprised of an alcohol. In one embodiment of the continuous phase, the phase is comprised of an pentanol. In general, the continuous phase should be inert relative to surface to be polished.

In one embodiment of the invention, the surfactant is an anionic, cationic or non-ionic surfactant. See e.g., McCutcheon's Volume 1: Emulsifiers & Detergents (1995 North American Edition) (MC Publishing Co., 175 Rock Road, Glen Rock, N.J. 07452). In another embodiment of the CMP solution, the surfactant is a charged surfactant wherein the charge is opposite that of the surface to be polished. In one embodiment of the surfactant, the charge is an anionic surfactant. In another embodiment of the anionic surfactant, the surfactant includes but is not limited to carboxylate, sulfate, sulfonate, phosphate, and any combination of them. In yet another embodiment of the anionic surfactant, the surfactant is sodium dodecyl sulfate (SDS). The surfactant selected must be able to form reversed micelles when combined with the dispersed and continuous phases and must be able to protect the polished surface from the dispersed phase. Following the same basic principle, the surfactant employed can also be cationic or nonionic as long as they can form stable reverse micelle system.

In still another embodiment of the CMP solution, the solution is free of abrasive substances or substantially-free of abrasive substances which can be selected from the ranges of less than 1% by weight, less than 0.1% by weight and less than 0.01% by weight.

Another embodiment of the invention is directed toward the process of making the CMP solutions of the invention.

In another embodiment of the invention, the CMP solution of the invention is combined with a solid phase to form a CMP slurry.

In one embodiment of the CMP slurry, the solid phase includes but is not limited to silica, alumina, ceria, titania, diamond, polymer, or nonpolymeric organic solids. In another embodiment of the solid phase, the phase is a silica based material. In yet another embodiment of the CMP slurry, the silica based material is fumed silica.

Another embodiment of the invention is a process for the chemical mechanical polishing of a surface which comprises of pad preparation such as conditioning, substrate loading, polishing, and post polishing clean. The polishing process includes maintaining at least a portion of the surface of the substrate in sliding frictional contact with at least a portion of the polishing layer of the substrate in the presence of the polishing slurry until the selected portions of the surface of the substrate are removed.

In one embodiment for the process of chemical mechanical polishing, the surface includes but is not limited to group I, II, and III metal oxides, group V, VI, and VII compounds, or mixed composites. The surfaces also include but is not limited to those surfaces used in the production of optical, photonic or microelectronic devices.

In another embodiment of the process of chemical mechanical polishing, the material removal rate can range selected from the group consisting of several angstroms to many microns per minute, about 5 Å to about 100 microns per minute and about 50 Å to about 10 micron per minute.

In another embodiment of the process of chemical mechanical polishing, the step height reduction efficiency is within the range of about 50% to about 100%. In yet another embodiment of the step height reduction efficiency, the range is about 60% to about 95%. In still another embodiment of the step height reduction efficiency, the range is about 65% to about 90%.

In another embodiment of the process of chemical mechanical polishing, the surface roughness (Rₐ) after polishing is within the range of about 1 to about 15 nm. In yet another embodiment of the surface roughness, the Rₐ is within the range of about 5 to about 10 nm.

In another embodiment of the surface roughness, the Rₐ is within the range of about 6.5 to about 7.5 nm.

In addition, these ranges for surface roughness may also be combined with the degree of Rₐ after exposure to 100% RH. The exposure time may be selected from a period of time selected from the ranges of about 6 hours to about 7 days, about 12 hours to about 4 days and about 24 hours to about 3 days. The Rₐ after these exposure times may be selected from the ranges consisting of about 2 to about 20 nm, about 5 to about 15 nm and about 8 to about 10 nm.

In another embodiment of the process of chemical mechanical polishing, the process deposits a thin layer of surfactant on the polished surface. As this is typically a single or double layer of the surfactant molecules. The thickness of this layer would be in the order of 2-4 nm.

Various combinations of the above embodiments are also within the scope of this invention. The invention will now be further described by way of the following non-limiting examples.

### Example 1

### L2 Microemulsion

A solution of sodium dodecyl sulfate (SDS) is prepared by dissolving 10.0 grams of SDS in 13.0 grams of DI (deionized) water. To the above solution, 77.0 grams of pentanol was added. The solution was then filtered using a 0.4 μm filter. A sample of potassium diphosphate (KDP) crystal is fixed onto a homemade carrier then polished on a polyurethane pad (IC1000, Rohm & Haas) with a bench top polisher (Struer Labopol-5). The down force is set at about 3-5 psi. The table speed is set at 50-150 rpm. The slurry flow rate is adjusted to about 60 mL/min. After 3 minutes of polishing, the sample is then cleaned with pentanol and then air dried. The material removal rate is then calculated based on the weight loss after polish. The following table lists the removal rate under various conditions.

TABLE 1
Material Removal Rate (MRR) of KDP Crystals

| Down Force (PSI) | Table Speed (rpm) | MRR (nm/min) |
|---|---|---|
| 3 | 50 | 3470 |
| 3 | 100 | 5890 |
| 4 | 100 | 8010 |
| 5 | 100 | 10300 |
| 5 | 150 | 12000 |
| 5 | 150 | 12010 |

### Example 2

To 950 grams of the solution described in Example 1 (10% water, 13% SDS, and 77% pentanol, all % by weight based on the total weight of the solution), 50 grams of fumed silica (Degussa 200) was added. The resulting slurry is then used in a polish similar to that described in Example 1. The removal rates under various conditions are listed in Table 2.

TABLE 2
Material Removal Rate of KDP Crystals

| Down Force (PSI) | Table Speed (rpm) | MRR (nm/min) |
|---|---|---|
| 4 | 100 | 12030 |
| 5 | 100 | 15300 |
| 5 | 150 | 17900 |

### Example 3

A solution is prepared according to the same procedure as described in Example 1 except lower amount of water (3 grams). A set of polishes was tested under one of the tested conditions of Table 1 (5 psi down force, 150 rpm table speed and slurry flow rate of 60 mL/min). The material removal rate and step height change for the KDP sample was examined every 30 seconds. Table 3 lists the material removal and step height reduction over time.

TABLE 3
Material removal and step height reduction
over polishing time for example 3

| | | | Step Height |
|---|---|---|---|
| Polishing time | Material Removal | Step Height | Reduction |
| (sec) | (nm) | Reduction (nm) | Efficiency, % |
| 30 | 637 | 560 | 87.9 |
| 60 | 1328 | 1024 | 77.1 |
| 120 | 1979 | 1520 | 76.8 |
| 240 | 2450 | 1689 | 68.9 |
| Average | | | 77.7 |

### Example 4

### Comparative

A solution is prepared according to the same procedure as described in Example 1 except the solution is in a L1 phase. More specifically, the relative amounts of pentanol and water are reversed (77% of water, 13% SDS and 10% pentanol, all percentages in percent by weight based on the total weight of the solution). In such a solution, regular micelles exist. Unlike Examples 1-3, the surface to be polished is in direct contact with water. A set of polishes were tested under one of the conditions listed in Table 1 (5 psi down force, 150 rpm table speed and slurry flow rate of 60 mL/min). The KDP sample was examined for removal rate and step height change after each 30 seconds. Table 4 lists the material removal and step height reduction.

TABLE 4
Material removal and step height reduction
over polishing time for example 4

| | | | Step Height |
|---|---|---|---|
| Polishing time | Material Removal | Step Height | Reduction |
| (sec) | (nm) | Reduction (nm) | Efficiency, % |
| 20 | 1502 | 365 | 24.3 |
| 40 | 3298 | 640 | 19.4 |
| 80 | 6504 | 1430 | 22.0 |
| Average | | | 21.9 |

The L1 microemulsion resulted in a decrease of step height reduction efficiency of about 71.8% relative to the L2 microemulsion tested in Example 3 (77.7%-21.9%/77.7%×100%).

### Example 5

A solution is prepared according to the same procedure as described in Example 1 except for the choice of surfactant. Instead of using SDS, a negatively charged surfactant, dodecyl trimethyl ammonium bromide (DTAB), a positively charged surfactant was substituted. BAS Pluronic 103 was used to represent a non-ionic surfactant. A set of polishes were conducted under a condition listed in Table 1 (5 psi down force, 150 rpm table speed and slurry flow rate of 60 mL/min, 1 min polishing). The polished KDP samples were then examined for surface roughness (Rₐ) after polishing. The surface roughness was determined using a stylus profilometer (Ambios XP). The samples were then stored in a chamber with a relative humidity (RH) of 100%. to test the effectiveness of protective layer formed by the surfactant molecules. The Table 5 lists the surface roughness results.

TABLE 5
Surface roughness vs. surfactants used during polishing

| | | Rₐ after 2 |
|---|---|---|
| | Rₐ after | days of exposure |
| Surfactant | polishing (nm) | to 100% RH (nm) |
| none | 12 | 38 |
| DTAB | 10 | 30 |
| P-103 | 8 | 26 |
| SDS | 7 | 9 |

It is clear that SDS yielded the most effective protective layer. This is a direct result of attraction between the opposite charges between the surfactant molecules (negative) and the polished surface (positive).

Whereas particular embodiments of this invention have been described above for purposes of illustration, it will be evident to those skilled in the art that numerous variations of the details of the present invention may be made without departing from the invention as defined in the appended claims. The scope of the present invention is intended to be defined by the appended claims and equivalents thereto.

1. A CMP solution for the polishing of surfaces which is a microemulsion with a reverse micelle system which comprises:
(a) a dispersed phase;
(b) a continuous phase; and
(c) a surfactant.

2. The CMP solution of claim 1, wherein the microemulsion is an L2 microemulsion.

3. The CMP solution of claim 2, wherein the amount of dispersed phase is about 5 to about 40% by weight, the amount of continuous phase is about 30% to about 94% by weight and the amount of surfactant is about 1 to about 30% by weight.

4. The CMP solution of claim 3, wherein the amount of dispersed phase is about 8 to about 25% by weight, the amount of continuous phase is about 55% to about 89% by weight and the amount of surfactant is about 3 to about 20% by weight.

5. The CMP solution of claim 4, wherein the amount of dispersed phase is about 10 to about 15% by weight, the amount of continuous phase is about 73% to about 82% by weight and the amount of surfactant is about 8 to about 12% by weight.

6. The CMP solution of claim 5, wherein the disperse phase is selected from the group consisting of water, an amine, an alcohol and mixtures thereof; the continuous phase is selected from the group consisting of an oil, a hydrocarbon, an alcohol, an amine, and mixtures thereof; and the surfactant is selected from the group consisting of anionic, cationic and non-ionic surfactant, wherein said surfactant form reversed micelles when combined with the dispersed and continuous phases and protects the polished surface from the dispersed phase.

7. The CMP solution of claim 6, wherein the amount of abrasive substances in the solution is less than 0.01% by weight.

8. A CMP slurry which comprises a solid material added to the CMP solution of claim 1.

9. The CMP slurry of claim 8, wherein the solid material is selected from the group consisting of silica, alumina, ceria, titania, diamond, polymers, and nonpolymeric organic solids.

10. The CMP slurry of claim 9, wherein the CMP solution is the CMP solution of claim 7.

11. A process of chemical mechanical polishing a surface of a substrate which comprises applying the CMP solution of claim 1 or a CMP slurry which comprises a solid material added to the CMP solution of claim 1 slurry of claim 8 to a surface and maintaining at least a portion of the surface of the substrate in sliding frictional contact with at least a portion of a polishing layer in the presence of the CMP solution or slurry until the selected portions of the surface of the substrate are removed.

12. The process of claim 11, wherein the material removal rate is about 50 Å to about 10 microns per minute.

13. The process of claim 12, wherein the step height reduction efficiency is within the range of about 65% to about 90%.

14. The process of claim 13, wherein the surface roughness (Rₐ) after polishing is within the range of about 6.5 to about 7.5 nm.

15. The process of claim 14, wherein post-polishing exposure to 100% relative humidity (RH) results in a surface roughness (Rₐ) of about 8 to about 10 nm.

16. The process of claim 13, wherein the process deposits a layer of surfactant on the polished surface with a thickness of 2-4 nm.

17. The process of claim 16, wherein the CMP solution is the CMP solution of claim 7.

18. The process of claim 16, wherein the CMP slurry is the CMP slurry of claim 10.
